(19) United States
(12) Patent Application Publication
(10) Pub. No.: US 2017/0082451 A1
(43) Pub. Date: Mar. 23, 2017

(54) METHOD AND DEVICE FOR NAVIGATION AND GENERATING A NAVIGATION VIDEO

(71) Applicant: Xiaomi Inc., Beijing (CN)

(72) Inventors: Guoming Liu, Beijing (CN); Long Xie, Beijing (CN); Zhiguang Zheng, Beijing (CN)

(73) Assignee: Xiaomi Inc., Beijing (CN)

(21) Appl. No.: 15/265,621

(22) Filed: Sep. 14, 2016

(30) Foreign Application Priority Data
Sep. 22, 2015 (CN) 201510609516.0

(51) Int. Cl. G01C 21/36; G06K 9/00; G11B 27/34; G11B 27/031; G01C 21/34; G11B 27/10

(52) U.S. Cl. CPC G01C 21/3647; G01C 21/3623; G01C 21/3492; G11B 27/102; G11B 27/34; G11B 27/031; G06K 9/00758

(57) ABSTRACT

Methods and apparatus are disclosed for navigation based on real-life video. A real-life navigation video segment for navigating from a starting point to an ending point may be compiled from pre-recorded real-life navigation video clips or portions of the pre-recorded real-life navigation video clips. The real-life navigation video clips used for compiling a navigation video segment may be chosen based on current navigation parameters such as the weather, time of the day. The compiled real-life navigation video segment may be played and synchronized with actual navigation.

### CROSS-REFERENCE TO RELATED APPLICATION

This application and claims priority to Chinese Patent Application No. 201510609516.0, filed Sep. 22, 2015, which is incorporated herein by reference in its entirety.

### TECHNICAL FIELD

The present disclosure generally relates to the field of wireless communication technology, and more particularly to methods and devices for navigation based on real-life video.

### BACKGROUND

Current navigation systems are based on maps. A user needs to identify abstract representation and symbols in a map while driving. Since some users may have slow response to navigation maps, they may not be able to follow navigation instructions in a map format in complicated road conditions with, for example, multi-intersection configurations.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a method for navigation is disclosed. The method includes obtaining navigation request information for a current navigation task; determining at least one navigation video segment based on at least one pre-stored navigation video clip according to the navigation request information, wherein each of the at least one pre-stored navigation video clip comprises a prior recording of at least a portion of a route corresponding to the navigation request being previously driven through; and performing the current navigation task by playing one of the at least one navigation video segment.

In another embodiment, a method for generating a navigation video clip is disclosed. The method includes obtaining navigation parameters entered by a user, wherein the navigation parameters comprise at least a navigation starting point and a navigation ending point; recording a video of roads while driving from the navigation starting point to the navigation ending point; associating the navigation parameters with the recorded video to obtain the navigation video clip; and uploading the navigation video clip to a database.

In yet another embodiment, a device for navigation is disclosed. The device includes a processor; a memory for storing instructions executable by the processor; wherein the processor is configured to: obtain navigation request information for a current navigation task; determine at least one navigation video segment based on at least one pre-stored navigation video clips according to the navigation request information, wherein each of the at least one pre-stored navigation video clip comprises a prior recording of at least a portion of a route corresponding to the navigation request being previously driven through; and perform the current navigation task by playing one of the at least one navigation video segment.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1A is a flow diagram illustrating a method for video navigation according to an exemplary embodiment.

FIG. 1B shows an implementation for shooting a real-life video clip when a route is driven through.

FIG. 2 is a flow diagram illustrating an embodiment of step S12 of FIG. 1A.

FIG. 3 is a flow diagram illustrating another embodiment of step S12 of FIG. 1A.

FIG. 4 is a flow diagram illustrating another embodiment of step S12 of FIG. 1A.

FIG. 5 is a flow diagram illustrating another further embodiment for video navigation based on FIG. 1A.

FIG. 6 is a flow diagram illustrating a method implemented in a server for video navigation based on FIG. 1A.

FIG. 7 is a flow diagram illustrating a method implemented in a terminal device for video navigation based on FIG. 1A.

FIG. 8 is a flow diagram illustrating a method for video navigation according to another exemplary embodiment.

FIG. 9 is a flow diagram illustrating an embodiment for playing navigation video.

FIG. 10 is a flow diagram illustrating a method for generating a navigation video clip according to an exemplary embodiment.

FIG. 11 is a block diagram illustrating a device for video navigation according to an exemplary embodiment.

FIG. 12 is a block diagram illustrating one implementation of the determining module of FIG. 11.

FIG. 13 is a block diagram illustrating another implementation of the determining module of FIG. 11.

FIG. 14 is a block diagram illustrating another implementation of the determining module of FIG. 11.

FIG. 15 is a block diagram illustrating another implementation of the determining module of FIG. 11.

FIG. 16 is a block diagram illustrating an implementation of the navigating module of FIG. 11.

FIG. 17 is a block diagram illustrating another implementation of the navigating module of FIG. 11.

FIG. 18 is a block diagram illustrating a device for navigation according to another exemplary embodiment.

FIG. 19 is a block diagram illustrating a device for generating a navigation video according to an exemplary embodiment.

FIG. 20 is a block diagram illustrating a terminal device for navigation or generation of a navigation video according to an exemplary embodiment.

FIG. 21 is a block diagram illustrating a server device for navigation according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of devices and methods consistent with aspects related to the invention as recited in the appended claims.

Terms used in the disclosure are only for purpose of describing particular embodiments, and are not intended to be limiting. The terms “a”, “said” and “the” used in singular form in the disclosure and appended claims are intended to include a plural form, unless the context explicitly indicates otherwise. It should be understood that the term “and/or” used in the description means and includes any or all combinations of one or more associated and listed terms.

It should be understood that, although the disclosure may use terms such as “first”, “second” and “third” to describe various information, the information should not be limited herein. These terms are only used to distinguish information of the same type from each other. For example, first information may also be referred to as second information, and the second information may also be referred to as the first information, without departing from the scope of the disclosure. Based on context, the word “if” used herein may be interpreted as “when”, or “while”, or “in response to a determination”.

By way of introduction, navigation methods based on an interface showing maps for roads and routes in the form of abstract geometric images and accompanying simplified symbols may be confusing to users having slow reaction time to abstract instructions not based on real-life images. The embodiments of the present disclosure use a compiled real-life video segment for each navigation task and thus provide more direct navigation instructions and relieve users from stress when driving on roads with complicated configurations. Video fragments in the compiled navigation video segment may be pre-obtained by real-life footage of particular roads shot when the roads were previously driven through. The user queries the navigation system for a navigation video segment by inputting into the navigation system a set of navigation parameters including at least a starting point (or starting position, used in this disclosure interchangeably with “starting point”) and ending point (or ending position, used in this disclosure interchangeably with “ending point”). The navigation parameters may further include other information for more accurate and synchronous video compilation, such as a geographic region name parameter, a road name, a season parameter, a weather parameter, an average driving speed and the like. The compiled video segment is played in the navigation interface of a navigation device providing visually direct driving instructions and improving user experience.

The navigation parameters may be manually input by the user into the navigation system. Alternatively, some of the parameters may be automatically obtained by the navigation system. For example, the navigation system may automatically determine the starting point, the average driving speed, the geographic region name, season, and weather with the help from an embedded GPS, a pre-stored map, and a server in communication with the navigation system. The navigation system may include a navigation terminal device and at least one server in communication with the navigation terminal device. Information, such as the navigation video source, maps, and weather, may be obtained, stored, and processed locally in the navigation terminal device or remotely by the server. The information is communicated between the navigation terminal device and the server when needed.

In this disclosure, a “video clip” refers to a unit of video pre-stored in the navigation system. A video “sub-clip” refers to a portion of a video clip that may be extracted from the video clip. A “navigation video segment” refers to a video segment that the navigation system compiles from stored video clips for a particular navigation task. A navigation video segment, as disclosed herein, may be an entire video clip, or a sub-clip, or combined multiple video clips, or combined multiple sub-clips (which may be extracted from the same video clip, or from different video clips).

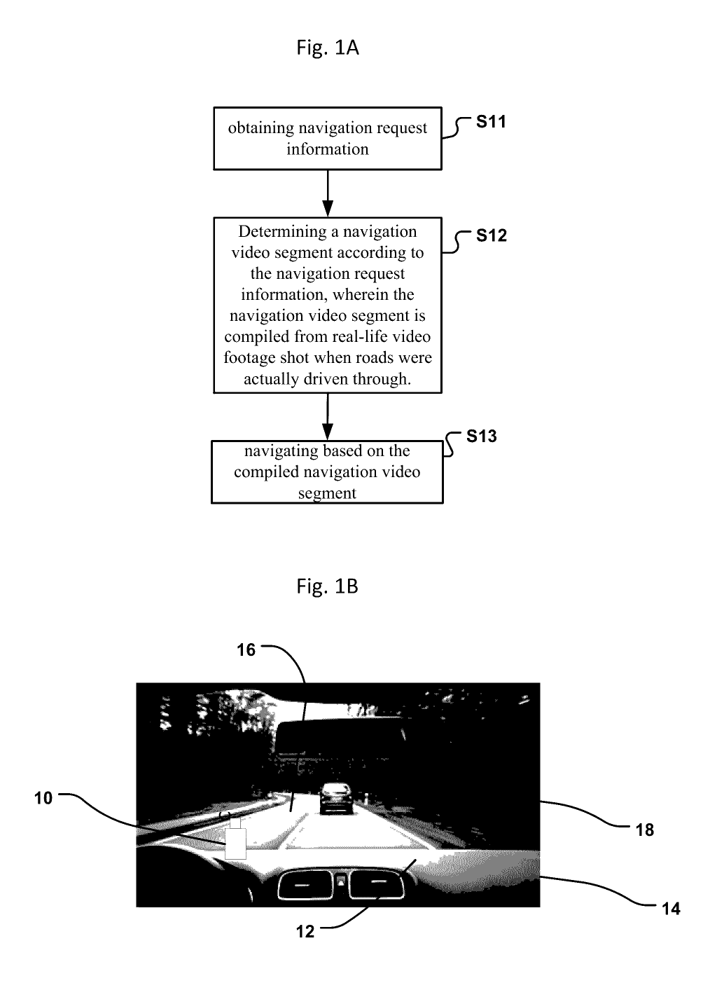

FIG. 1A is a flow diagram illustrating a method for video navigation according to an exemplary embodiment. The method may be applied to a navigation system. In step S11, navigation request information is obtained by the navigation system. In step S12, the navigation system determines at least one navigation video segment according to the navigation request information, wherein the navigation video is obtained by compiling real-life video footage or clips shot when roads were actually driven through. For example, as illustrated in FIG. 1B, the real-life video clip is shot by placing a video camera 10 on the driver's side of the dashboard 12 of a vehicle 14 and facing the road 16 in front of the windshield 18.

In step S13, the navigation system navigates based on one of the compiled navigation video segments. Navigating with real-life video may decrease driver reaction time compared to navigation interface based on maps and thus may reduce number of mistakes in following navigation instructions in locations with complex road configuration and may relieve a driver from excess stress.

The navigation request information may include navigation parameters such as navigation starting point and a navigation ending point. Step S12 may be implemented in the following non-limiting alternative manners in compiling suitable video segments for navigating from the starting point to the end point.

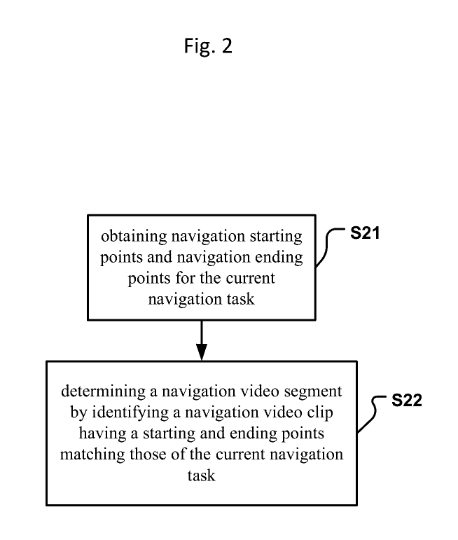

FIG. 2 shows a flow diagram illustrating one implementation for step S12, including steps S21 and S22. In step S21, the navigation system obtains the navigation starting point and navigation ending point for the current navigation task. The navigation system may store in its storage multiple navigation video clips each having a starting navigation point and an ending navigation point. In step S22, the navigation system compares the input navigation parameters (starting and ending points) with the information for the stored navigation video clips and identifies a navigation video clip having a starting point and ending point that match those of the navigation request information.

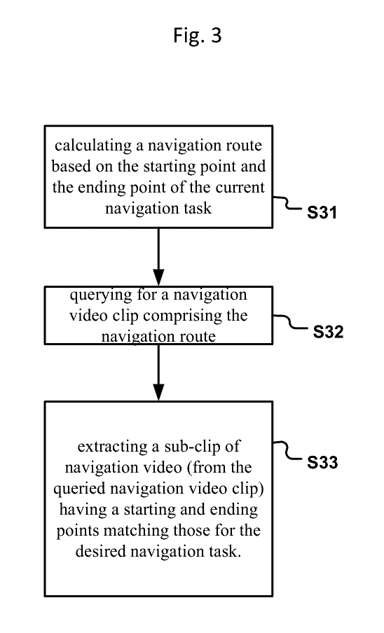

FIG. 3 is a flow diagram illustrating a second implementation of step S12 in compiling a suitable navigation video segment by the navigation system, including steps S31, S32 and S33. In this implementation, the navigation task may be a short route and thus only a sub-clip of the one of the navigation video clips stored in the navigation system may be needed for the navigation task. Thus, the navigation system in step S31 calculates a navigation route based on the input navigation starting point and the navigation ending point. In step S32, the navigation system queries for a navigation video clip among the stored video clips that encompasses the shorter navigation route. In step S33, the navigation system extracts a sub-clip of navigation video (from the queried navigation video clip) having a starting and ending points matching those for the desired navigation task. For ease of extracting sub-clip of a video clip, video frames of a video clip may be marked with route information which may be used for matching to the starting point and ending point of the current navigation route. The marking may be kept, for example, in the frame headers of the video.

For example, the navigation starting point and the navigation ending point of the current navigation task may be A and B. The corresponding navigation route is thus A→B. The navigation system may find a stored navigation video clip shot for navigation route CD (the navigation starting point is C and the navigation ending point is D), and the navigation route AB is a sub-section of the navigation route CD. The navigation system thus may extract a sub-clip corresponding to AB from the navigation video clip CD. Here, the navigation parameters corresponding to the navigation video clip CD include the road names corresponding to the navigation route AB or identifications point A and point B.

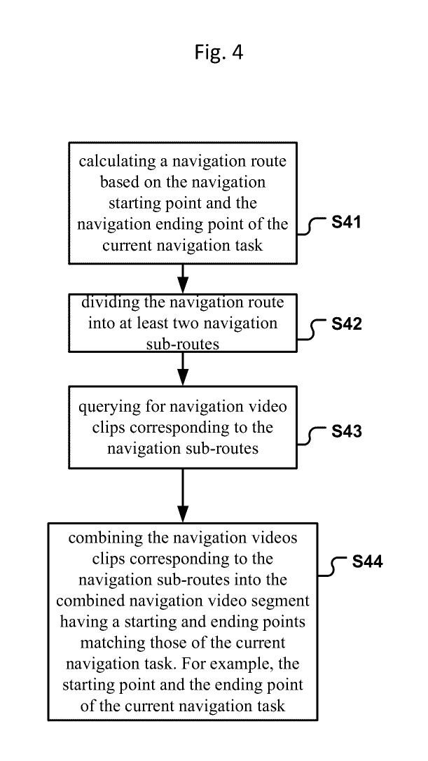

FIG. 4 is a flow diagram illustrating a third implementation of step S12 in compiling a navigation video segment for the current navigation task including steps S41, S42 and S43. In this embodiment, the current navigation task may be a very long route such that the stored navigation video clips in the navigation system device may be combined to create a compiled navigation video segment having a starting and ending point that match those for the current navigation task. In step S41, the navigation system calculates a navigation route based on the navigation starting point and the navigation ending point of the current navigation task. In step S42, the navigation system divides the navigation route into at least two navigation sub-routes. In step S43, the navigation system queries for the navigation video clips or sub-clips (from the stored navigation video clips stored in the navigation system) corresponding to the navigation sub-routes. In step S44, the navigation system combines the navigation video clips or sub-clips corresponding to the navigation sub-routes into a combined navigation video segment having a starting and ending points matching those of the current navigation task. For example, the starting point and the ending point of the current navigation task may be A and B, corresponding to a navigation route AB. The route AB is longer than any of the route with a stored navigation video clip. The navigation system may divide the navigation route AB into, e.g., three navigation sub-routes AE, EF, and FB. The navigation video clips corresponding to sub-routes AE, EF, and FB may be found in the stored video clips in the navigation system. Those video clips may be combined to yield a compiled navigation video segment having a starting point A, and an ending point B.

The implementations above for identifying a navigation video segment are not mutually exclusive. Multiple navigation video segments may be found based on any one or combination of these implementations for a particular navigation task.

The navigation video segment compiled above (according to FIG. 2, 3, or 4) may be a new video stream compiled from the video clips or sub-clips. For example, the video clips may be stored in a server, and a navigation terminal may download the sub-clips or clips needed for navigation from the server and generate a stream of navigation video segment at the terminal. Alternatively, a navigation video segment may be represented by a collection of markers or pointers into the stored video clips and when navigating, the navigation video may be generated in real time from stored video clips based on the marker or pointer information.

The navigation video clips may be pre-shot under various conditions. For example, a video clip corresponding to particular starting and ending points may be recorded either on a rainy day, cloudy day, snowing day, or sunny day. It may be recorded during a particular season. It may be recorded when the vehicle with the camera was driven with a particular average speed. It may be recorded through different road options between the starting and ending points. Some of these parameters, such as season and weather may be related to the lighting condition of the video. For example, a navigation video clip recorded at 6:00 PM in summer may be bright and may show clear road signs and surrounding buildings but may be dark if recorded at 6:00 pm during winter time. Thus, for improve navigation and visual accuracy, navigation video segment for the current navigation task may be compiled from the stored video clips considering these other navigation parameters including but not limited to geographic region name, road name, season, weather, average speed and the like. These parameters may be input by the user, or they may be obtained by the navigation system automatically with the help from embedded GPS and external networks in communication with the navigation system. For example, the navigation system may obtain geographic region name, road name, and driving speed by combining GPS information and a map stored within the navigation system. It may further obtain weather information from an external weather server. In addition, it may maintain system time and date and thus may automatically determine the season. The navigation terminal device may compile the navigation video segment for the current navigation task that best matches all these navigation parameters. The more navigation parameters in the navigation request, the more accurate the compiled navigation video segment may be. The navigation video clips, accordingly, may be associated with a set of these parameters. Some of the navigational parameters of the navigation video clip may be global to the video clip. For example, the entire video clip may be shot under the same weather condition, or about the same lighting condition. These parameters may be stored in the metadata of the video clip. Other parameters may be in real-time. For example, driving speed may vary within the video clip. These parameters may be recorded in, for example, the header of the video frames. All these parameter, global, or real-time, may alternatively be stored in a separate data structure of data file that may be associated and synchronized with the video clip.

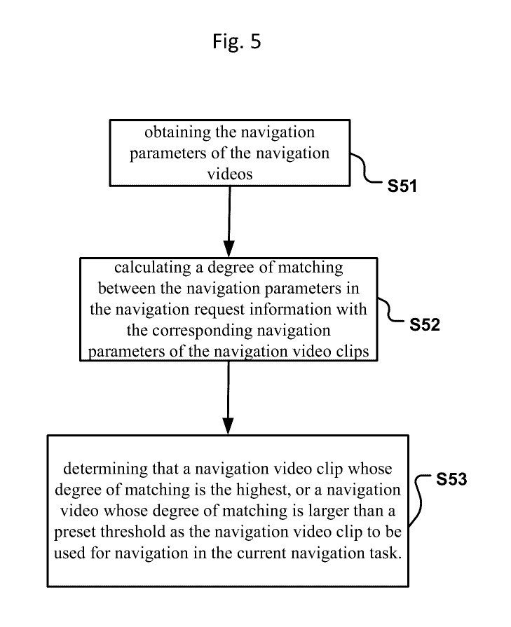

FIG. 5 is a flow diagram illustrating a method for navigating according to another exemplary embodiment. For this embodiment, the navigation request information may further includes at least one of the following navigation parameters: a geographic region name, a road name, a season, a weather, an average driving speed, and a driving distance. For FIG. 5, in case that there are at least two navigation video clips having matching navigation starting point and the navigation ending point with the current navigation task, the step of selection/compilation of the more appropriate video clip may be further based on the other navigation parameters. Specifically, in step S51, the navigation system obtains the corresponding navigation parameters of the pre-shot navigation video clips. These parameters may be recorded in the metadata or headers of the pre-shot navigation video clips. In step S52, the navigation system calculates a degree of matching between the navigation parameters in the navigation request information with the corresponding navigation parameters of the navigation video clips. In step S53, the navigation system determines that a navigation video clip whose degree of matching is the highest, or a navigation video whose degree of matching is larger than a preset threshold as the navigation video clip to be used for navigation in the current navigation task. The navigation system may alternatively determine a preset number of top matches as candidate video clips for user selection. The above embodiment applies to all three implementation discussed above in FIGS. 2-4.

For example, there may be three navigation videos, Video 1, Video 2, and Video 3, all having navigation starting point A and the navigation ending point B. The navigation request information further includes:

season parameter being summer;

weather parameter being rainy;

average driving speed parameter being 40 km/h; and

road name parameter being Road A.

The navigation parameters of Video1, Video2, and Video3 are shown in Table 1.

TABLE 1

| | | | | | The degree of matching |
|---|---|---|---|---|---|
| | | | Average | | with the navigation |
| | | | driving | | parameters of the |
| | | | speed | Road | navigation request |
| | Season | Weather | (km/h) | name | information |
| Video1 | Summer | rainy | 30 | Road A | 75% |
| Video2 | Spring | sunny | 60 | Road A | 25% |
| Video3 | Summer | sunny | 40 | Road B | 50% |

The degree of matching may be calculated by calculating the percentage of number of parameters that are a match. From Table 1, the degree of matching for the parameters of Video1 and the corresponding navigation parameters of the navigation request information is the highest at 75%. Thus, Video 1 is determined as the navigation video clip among the three clips to be used for the current navigation task. Alternatively, the navigation system may present all clips having a degree of matching above a threshold, e.g., 50%, or predetermined number of top matches, e.g., top two matches, to the user to select which video clips is to be used in the current navigation task.

The method of the present disclosure may either be applied to a server or a navigation terminal device. The terminal device may be a mobile phone, a tablet computer, a laptop computer, a digital broadcasting terminal, a message transceiver device, a game console, a personal digital assistant and the like.

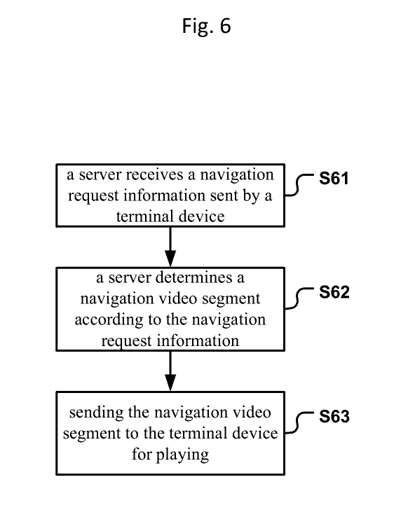

FIG. 6 is a flow diagram illustrating the method above applied to and adapted in a navigation server. The navigation server may be in communication with one or more navigation terminal devices. In step S61, the server receives navigation request information sent by a terminal device. In step S62, the server compiles a navigation video segment according to the navigation request information. In step S63, the server sends the navigation video segment to the terminal device, causing the terminal device to play the navigation video. Here, the term “terminal”, “terminal device”, or “navigation terminal”, or “navigation terminal device” are used interchangeably. The advantage of processing the video compilation in the server and pushing video segments from the server onto the terminal is that the video processing capability requirement for the terminal device may be relaxed and that the terminal device need not to pre-store video clips.

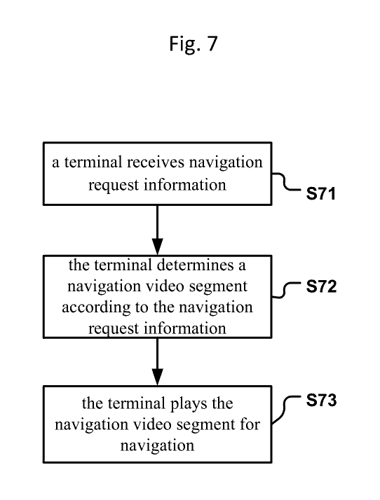

FIG. 7 is a flow diagram illustrating the method of FIG. 1A for navigating applied in a terminal device. In step S71, the terminal receives a navigation request information entered by the user or automatically obtain some navigation parameters. In step S72, the terminal determines and compiles the navigation video segment matching with the navigation request information. In step S73, the terminal plays the navigation video for navigating from the starting point to the end point. For this implementation, the terminal device may pre-store the navigation video clips and perform the video compilation function locally. The advantage of this implementation is the reduced reliance on network communication with a server.

Either the server in FIG. 6 or the terminal device in FIG. 7 may find multiple matching video clips. In that case, the user may be prompt to make a selection. These video clips may correspond to some parameters that are not part of the set of input parameters for the current navigation task. Those parameters may be shown together with the options so that the user can make an informed choice.

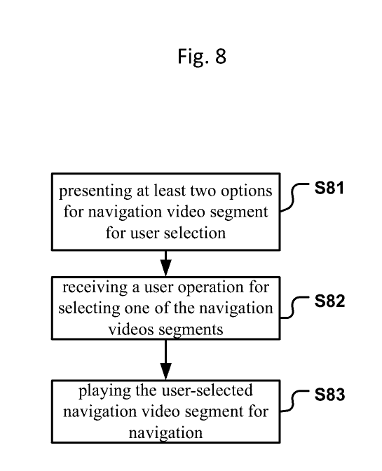

FIG. 8 is a flow diagram illustrating a method for letting the user choose a compiled navigation video segment from multiple navigation video segments. FIG. 8 applies to either the terminal or the server. FIG. 8 applies when at least two navigation video segments matching the navigation request information are identified. In step S81, the at least two navigation video segments are displayed and presented to the user as options. In step S82, user selection as to which video segment to be used for navigation is received. In step S83, the user-selected navigation video segments is played for navigation. For step S81, other information about each of the optional navigation route may be shown to the user for making an informed choice. For example, the optional video segments may be associated with some navigational parameters that are not part of the user input. Those parameters may be presented to the user either directly or indirectly following some analytical processing such that the user can make an informed decision For example, may be the user did not request navigation video based on whether tolls are collected for roads involved in a navigation route. Two otherwise equivalent routes with navigation videos may be found. One of them may involve toll road and the other may involve no toll road. The information about tolls may be provided together with the two route choices to the user for selection. Alternatively, the navigation system may make a recommendation based on the recorded user habit as to whether the user tends to avoid toll roads or not.

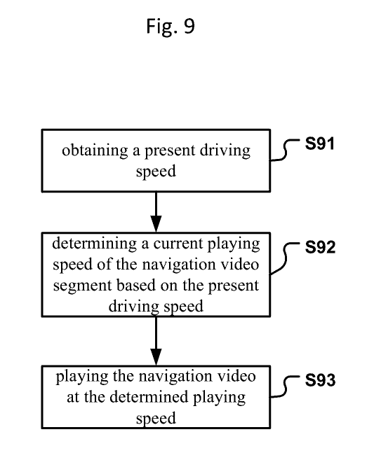

FIG. 9 is a flow diagram illustrating a method for displaying navigation video segment with a playing speed dynamically adjusted to synchronize with the actual navigation. In step S91, a current real-time driving speed is continuously (or periodically) monitored or obtained. In one implementation, the speed may be calculated from real time GPS position measurement (or position measurement based on Wi-Fi or cellular location technologies), pre-stored map information, and a system time that keeps track of the driving duration. In step S92, a playing speed of the navigation video segment based on the measured current driving speed and the driving speed within the navigation video segment is determined dynamically. For example, the current driving speed may be compared with the driving speed recorded in the navigation video segment (stored in, for example, frame headers of the navigation video). IF the current driving speed is the same as the recorded driving speed within the navigation video, then a normal playing speed is maintained, If the current driving speed is faster than the recorded speed, then the navigation video segment may be played at a faster playing speed such that the video and the actual driving is synchronized. Similarly, if the current driving speed is lower than the corresponding recorded speed in the video, then the video segment may be played at a lower playing speed to emulate the slower actual driving speed. The current driving speed may be monitored in real-time and thus the playing speed of the video segment may be adjusted dynamically in real-time. In step S93, the navigation video segment is played at the determined dynamic playing speed.

In another implementation of the method of FIG. 1, the terminal device and the server may communicate with each other in performing the navigation task. The method may further include periodically synchronizing navigation data including navigation video clips and other data via a communication network. The navigation data may then be stored in a local navigation storage in the navigation terminal device. For example, the navigation video from the server in the networks may be periodically downloaded and updated in advance in the terminal device when the communication link between the terminal device and the server is relatively speedy, e.g., when the link is based on Wi-Fi. In such a way, the terminal device may not need to rely on any data communication network at all times.

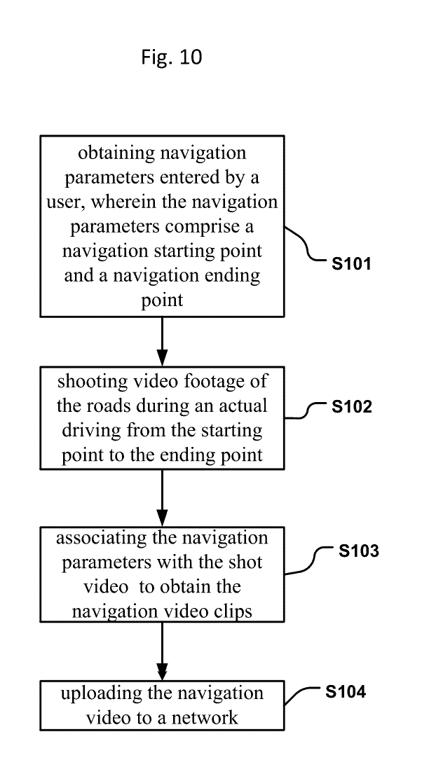

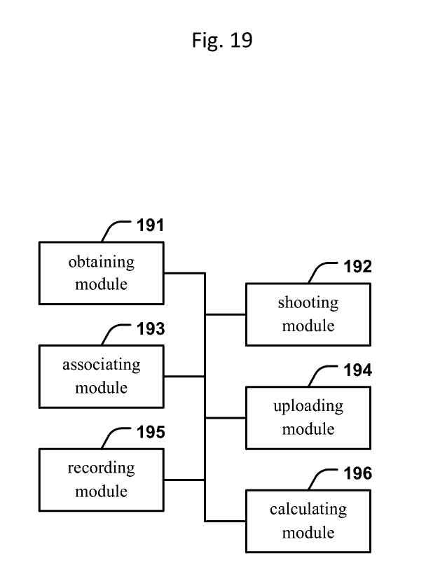

A method for generating a navigation video is further provided in an exemplary embodiment of the present disclosure as shown by the flow diagram of FIG. 10. The method may be applied to a terminal device such as a mobile phone, a tablet computer, a laptop computer, a digital broadcasting terminal, a message transceiver device, a game console, a personal digital assistant, a tachograph and the like. In step S101, the terminal device obtains navigation parameters entered by a user, wherein the navigation parameters include navigation starting point and navigation ending point. In step S102, the terminal device perform a video shooting of the road during an actual driving from the starting point to the ending point. In step S103, an association between the navigation parameters and the video is established and a navigation video clip is thus created. The navigation parameters may be associated with the navigation clip by storing the navigation parameters in the metadata and/or frame headers of the navigation clip. Alternatively, the navigation parameters may be associated with the navigation clip using a pre-defined separate data structure of data files. In step S104, the navigation video with the associated navigation parameters is uploaded to a network. Thus, when another user needs navigation video for the same route, this pre-recorded navigation video may be used. Further, the method of FIG. 19 may include recording driving speeds at all times or periodically and calculating an average driving speed based on the recorded driving speeds. Correspondingly, the step S103 may further include associate the average speed with the recorded video in ways similar to those described above. Other parameters, such as driving distance may be similarly recorded and associated with the video in creating the navigation video clip. Additionally or alternatively, the router markers may be obtained while the navigation video clip is recorded. The router markers may be used to mark points on the route being driven. The marker information may be associated with the video in similar ways as discussed above. The marker information may be used to identify sub-clips of the recorded navigation video clips having particular starting and ending points corresponding to the markers.

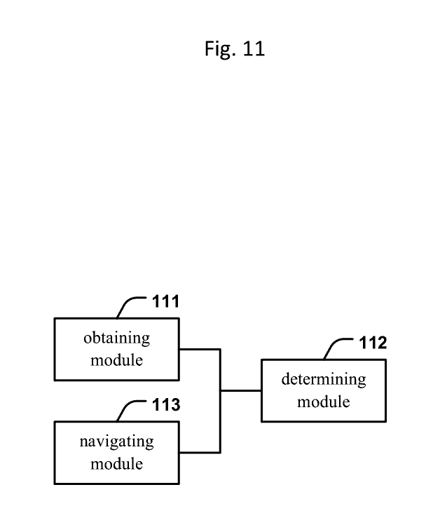

FIGS. 11-19 show block diagrams of embodiments of a device based on the method embodiments discussed above. FIG. 11 illustrates a device for video navigation according to an exemplary embodiment. The device may be implemented as an entire or a part of an electronic device by using hardware, software or any combination thereof. As shown in FIG. 11, the device for video navigation may include an obtaining module 111 configured to obtain navigation request information including a navigation starting and ending point; a determining module 112 configured to determine a navigation video segment according to the navigation request information, wherein the navigation video segment is the video obtained from video clips shot when roads were actually driven through; and a navigating module 113 configured to navigate based on the navigation video segment.

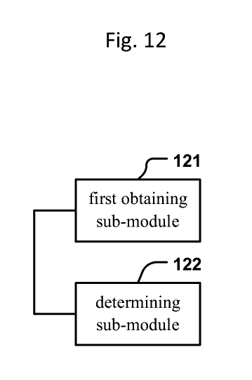

FIG. 12 is a block diagram illustrating an implementation of the determining module 112 according to an exemplary embodiment including: a first obtaining sub-module 121 configured to obtain the navigation starting points and navigation ending points of the navigation video clips; and a determining sub-module 122 configured to determine a navigation video segment having a starting and an ending point matching those of the navigation request information.

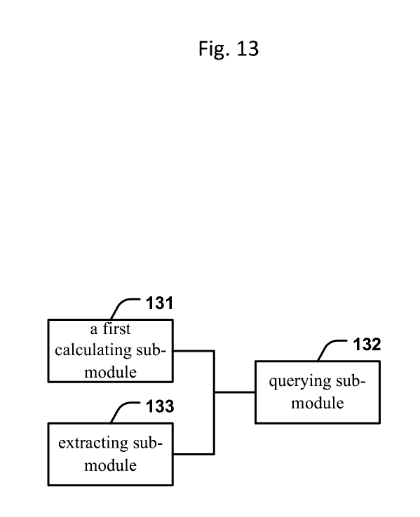

FIG. 13 is a block diagram illustrating another implementation of the determining module 112 according to an exemplary embodiment. The implementation includes a first calculating sub-module 131 configured to calculate a navigation route based on the navigation starting point and the navigation ending point of the current navigation task; a querying sub-module 132 configured to query for the navigation video which includes the navigation route; and an extracting sub-module 133 configured to extract a video sub-clip corresponding to the calculated navigation route from a navigation video clip that includes the calculated navigation route.

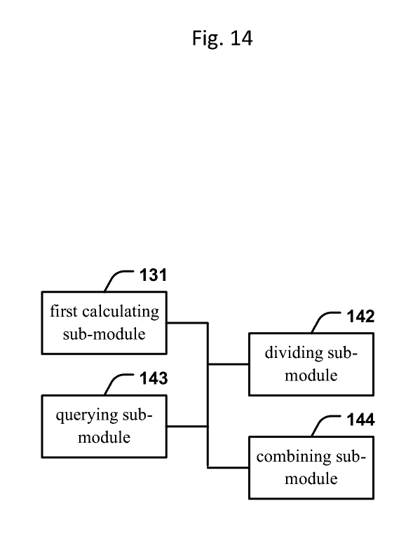

FIG. 14 is a block diagram illustrating yet another implementation of the determining module 112 according to an exemplary embodiment. The implementation includes a first calculating 131 sub-module configured to calculate a navigation route based on the navigation starting point and the navigation ending point of the current navigation task; a dividing sub-module 142 configured to divide the calculated navigation route into at least two navigation sub-routes; a querying sub-module 143 configured to query for the navigation video segments corresponding to the navigation sub-routes; and a combining sub-module 144 configured to combine the navigation video clips corresponding to the navigation sub-routes to obtain the navigation video segment having starting and ending point that matches with the navigation starting and points of the current navigation task.

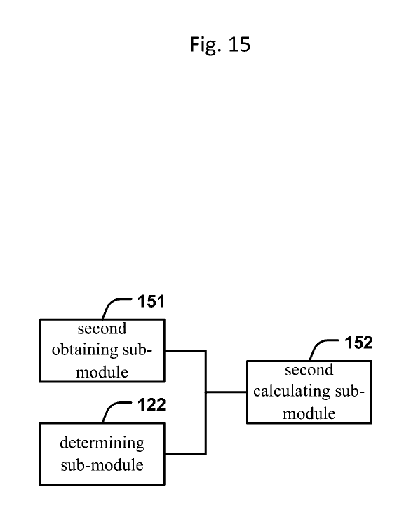

FIG. 15 is a block diagram illustrating another implementation of the determining module 112 according to an exemplary embodiment. In this implementation, besides the navigation starting and ending points, the navigation request information further includes at least one of the following navigation parameters: a regional name, a road name, a season, weather, an average driving speed, and a driving distance. The determining module 112 further includes a second obtaining sub-module 151 configured to, in case that at least two navigation videos segments are found to have navigation starting point and ending point matching those of the current navigation task, obtain the navigation parameters; a second calculating sub-module 152 configured to calculate the degrees of matching of the navigation parameters; and a determining sub-module 122 configured to identify a navigation video segments whose degree of matching is the greatest, or whose degree of matching is larger than a preset threshold to be used for current navigation task. Alternatively, the determining sub-module 122 may identify a predetermined number of navigation video segments having a relatively high degree of matching.

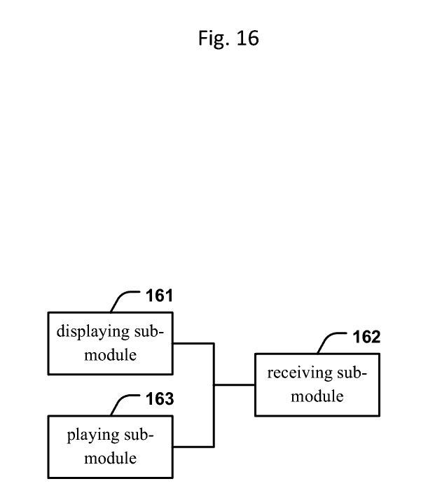

FIG. 16 is a block diagram illustrating an implementation of the navigation module 113 according to an exemplary embodiment. In this implementation, the navigating module 113 comprises a displaying sub-module 161 configured to display as options to the user at least two navigation video segments according to the navigation request information; a receiving sub-module 162 configured to receive a user operation for selecting one of the navigation video segments; a playing sub-module 163 configured to play the selected navigation video segment.

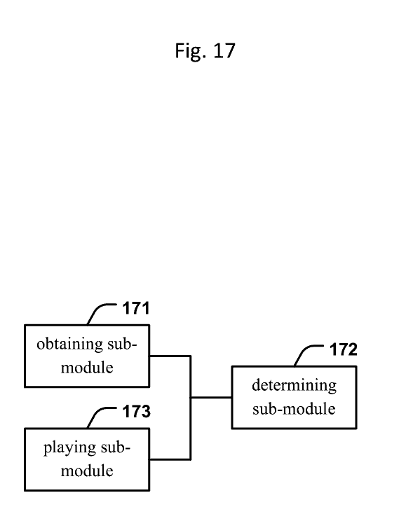

FIG. 17 is a block diagram illustrating another implementation of the navigation module 113 according to an exemplary embodiment. The navigating module 113 includes an obtaining sub-module 171 configured to obtain a present driving speed; a determining sub-module 172 configured to determine a playing speed of the navigation video segment based on the present driving speed; a playing sub-module 173 configured to play the navigation video at the playing speed.

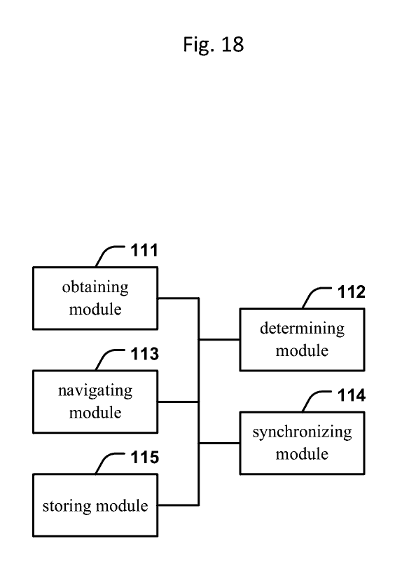

FIG. 18 is a block diagram illustrating a device for navigation according to another exemplary embodiment based on FIG. 11. As shown in FIG. 18, the device is applied to a terminal and further includes a synchronizing module 114 configured to synchronize navigation data from the network, wherein the navigation data include the navigation video. The device further includes a storing module 115 configured to store the navigation data locally.

FIG. 19 is a block diagram illustrating a device for generating a navigation video clip according to an exemplary embodiment. As shown in FIG. 19, the device includes an obtaining module 191 configured to obtain navigation parameters entered by a user, wherein the navigation parameters include a navigation starting point and a navigation ending point; a shooting module 192 configured to shoot a video clip of roads from the starting point to the ending point. The device further includes an associating module 193 configured to associate the navigation parameters with the video to obtain a navigation video clip. The device further includes an uploading module 194 configured to upload the navigation video clip to a network. Optionally, the method may include a recording module 195 configured to record real-time driving speed while shooting the video and a calculating module 196 configured to calculate an average driving speed between the starting point and ending point. The associating module 193 is further configured to associate the real-time driving speed and the average driving speed with the video clip.

With respect to the devices of FIGS. 11-19, the specific manners that each module or sub-module performs various operations have been described in detail in the method embodiments. The relevant portions of the description in the method embodiments apply.

Each module or unit discussed above for FIG. 8-13, such as the obtaining module, the determining module, the navigating module, the first obtaining sub-module, the determining sub-module, the first calculating sub-module, the extracting sub-module, the querying sub-module, the first calculating sub-module, the dividing sub-module, the combining sub-module, the second obtaining sub-module, the second calculating sub-module, the displaying sub-module, the receiving sub-module, the playing sub-module, the synchronizing module, the storing module, the associating module, the shooting module, the uploading module, the calculating module, and the recording module may take the form of a packaged functional hardware unit designed for use with other components, a portion of a program code (e.g., software or firmware) executable by the processor 2020 or the processing circuitry that usually performs a particular function of related functions, or a self-contained hardware or software component that interfaces with a larger system, for example.

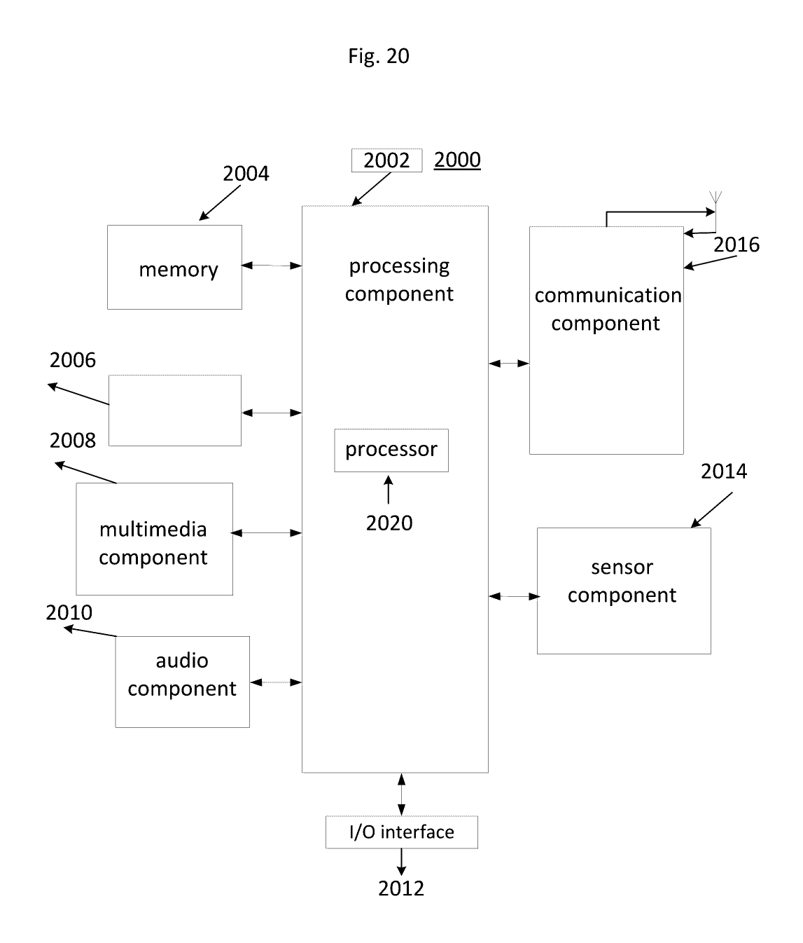

FIG. 20 is a block diagram illustrating a device for navigating or generating a navigation video according to an exemplary embodiment, the device is suitable for the terminal device. For example, the device 2000 may be the video camera, recording device, mobile phone, computer, digital broadcasting terminal, message transceiver device, game console, tablet device, medical facility, fitness facility, personal digital assistant and the like.

The device 2000 may include one or more of the following components: a processing component 2002, a memory 2004, a power component 2006, a multimedia component 2008, an audio component 2010, an input/output (I/O) interface 2012, a sensor component 2014, and a communication component 2016.

The processing component 2002 controls overall operations of the device 2000, such as the operations associated with display, telephone calls, data communications, camera operations, and recording operations. The processing component 2002 may include one or more processors 2020 to execute instructions to perform all or part of the steps in the above described methods. Moreover, the processing component 2002 may include one or more modules which facilitate the interaction between the processing component 2002 and other components. For instance, the processing component 2002 may include a multimedia module to facilitate the interaction between the multimedia component 2008 and the processing component 2002.

The memory 2004 is configured to store various types of data to support the operation of the device 2000. Examples of such data include instructions for any applications or methods operated on the device 2000, contact data, phonebook data, messages, pictures, video, etc. The memory 2004 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2006 provides power to various components of the device 2000. The power component 2006 may include a power management system, one or more power sources, and any other components associated with the generation, management, and distribution of power for the device 2000.

The multimedia component 2008 includes a display screen providing an output interface between the device 2000 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 2008 includes a front camera and/or a rear camera. The front camera and the rear camera may receive an external multimedia datum while the device 2000 is in an operation mode, such as a photographing mode or a video mode. Each of the front camera and the rear camera may be a fixed optical lens system or have optical focusing and zooming capability.

The audio component 2010 is configured to output and/or input audio signals. For example, the audio component 2010 includes a microphone (“MIC”) configured to receive an external audio signal when the device 2000 is in an operation mode, such as a call mode, a recording mode, and a voice recognition mode. The received audio signal may be further stored in the memory 2004 or transmitted via the communication component 2016. In some embodiments, the audio component 2010 further includes a speaker to output audio signals.

The I/O interface 2012 provides an interface between the processing component 2002 and peripheral interface modules, the peripheral interface modules being, for example, a keyboard, a click wheel, buttons, and the like. The buttons may include, but are not limited to, a home button, a volume button, a starting button, and a locking button.

The sensor component 2014 includes one or more sensors to provide status assessments of various aspects of the device 2000. For instance, the sensor component 2014 may detect an open/closed status of the device 2000, relative positioning of components (e.g., the display and the keypad, of the device 2000), a change in position of the device 2000 or a component of the device 2000, a presence or absence of user contact with the device 2000, an orientation or an acceleration/deceleration of the device 2000, and a change in temperature of the device 2000. The sensor component 2014 may include a proximity sensor configured to detect the presence of a nearby object without any physical contact. The sensor component 2014 may also include a light sensor, such as a CMOS or CCD image sensor, for use in imaging applications. In some embodiments, the sensor component 2014 may also include an accelerometer sensor, a gyroscope sensor, a magnetic sensor, a pressure sensor, or a temperature sensor.

The communication component 2016 is configured to facilitate communication, wired or wirelessly, between the device 2000 and other devices. The device 2000 can access a wireless network based on a communication standard, such as Wi-Fi, 2G, 3G, LTE or 4G cellular technologies, or a combination thereof. In an exemplary embodiment, the communication component 2016 receives a broadcast signal or broadcast associated information from an external broadcast management system via a broadcast channel. In an exemplary embodiment, the communication component 2016 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 2000 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium such as memory 2004 including instructions executable by the processor 2020 in the device 2000, for performing the above-described navigation methods for a terminal device. For example, the non-transitory computer-readable storage medium may be a ROM, a RAM, a CD-ROM, a magnetic tape, a floppy disc, an optical data storage device, and the like.

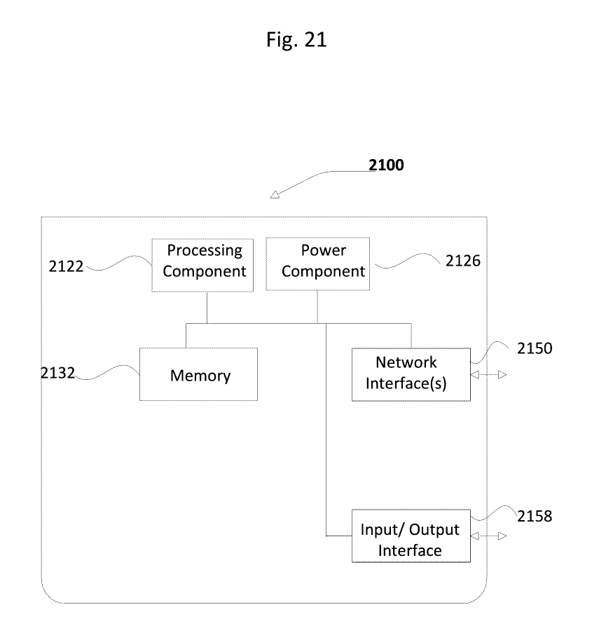

FIG. 21 is a block diagram of a device for video navigation according to an exemplary embodiment. For example, the device 2100 may be a server. The device 2100 may include a processing component 2122 (e.g. one or more processors), and the memory 2132 for storing the instructions executable by the processing component 2122 for a video navigation application comprising one or more modules discussed above.

The device 2100 may also include a power supply 2126 for device 2100, a wired or wireless network interfaces 2150 for connecting the device 2100 to network or to a terminal device such as the device of 2000 in FIG. 20. The device 2100 further comprises an input/output interface 2158. The device 2100 can be operated based on the operating systems stored in the memory 2132, such as Windows Server™, Mac OS X™, Unix™, Linux™, FreeBSD™, or the like.

A non-transitory computer readable storage medium having stored therein instructions is further disclosed. The instructions, when executed by the processor of the device 2010, cause the device 2010 to perform the above described video navigation methods for a server. For example, the method may include obtaining navigation parameters entered by a user, the navigation parameters include navigation starting point and navigation ending point; location shooting for road, stop shooting when arrived the navigation ending point to obtain a shooting video; associating the navigation parameters with the shooting video to obtain a navigation video; uploading the navigation video to network. The method may further include: recording driving speed; calculating an average driving speed based on the driving speed. The processing of associating the navigation parameters with the shooting video above may include: taking the average driving speed as a navigation parameter to associate it with the shot video.

A non-transitory computer readable storage medium having stored therein instructions that, when executed by the processor of the device 2000 or the device 2100, causes the device 2000 or the device 2100 to perform the above described method for navigating, including: obtaining navigation request information; determining a navigation video matching with the navigation request information, wherein the navigation video is a video obtained from location shooting of a road; navigating based on the navigation video. The navigation request information may include navigation parameters of a navigation starting point and a navigation ending point. The processing of determining the navigation video matching with the navigation request information includes: obtaining navigation starting points and navigation ending points of navigation videos; determining a navigation video, both the navigation starting point and the navigation ending point of which are the same as those of the navigation request information as the navigation video matching with the navigation starting point and the navigation ending point.

Alternatively, the navigation request information may include navigation parameters of a navigation starting point and a navigation ending point. The processing of determining the navigation video matching with the navigation request information may include: calculating a navigation route based on the navigation starting point and the navigation ending point; querying for the navigation video which including the navigation route; cutting out a navigation video corresponding to the navigation route from the navigation video including the navigation route, and determining the navigation video corresponding to the navigation route as the navigation video matching with the navigation starting point and the navigation ending point.

Alternatively, the navigation request information may include navigation parameters of a navigation starting point and a navigation ending point. The processing of determining the navigation video that matches the navigation request information includes: calculating a navigation route based on the navigation starting point and the navigation ending point; dividing the navigation route into at least two navigation sub-routes; querying for the navigation videos corresponding to the navigation sub-routes respectively; splicing the navigation videos corresponding to the navigation sub-routes to obtain the navigation video matching with the navigation starting point and the navigation ending point.

Alternatively, the navigation request information may further include at least one of the following navigation parameters: a regional name, a road name, a season, a weather, an average driving speed, a driving distance. In the case that at least two navigation videos matching with the navigation starting point and the navigation ending point are obtained by querying, the processing of determining a navigation video matching with the navigation request information may further include: obtaining the navigation parameters of the navigation videos; calculating the matching degrees of the navigation parameters of the navigation request information with respect to the navigation parameters of the navigation videos; determining a navigation video whose matching degree is the largest as the navigation video matching with the navigation request information, or determining navigation videos whose matching degrees are larger than a preset threshold as navigation videos matching with the navigation request information, or determining a predetermined number of navigation videos whose matching degrees are relatively high as navigation videos matching with the navigation request information.

In another embodiment, navigating according to the navigation video when the method is applied to a network may further include sending the navigation video to a terminal for playing.

In another embodiment, navigating according to the navigation video when the method is applied to a terminal may further include playing the navigation video.

In another embodiment, wherein when at least two navigation videos matching with the navigation request information are determined, the processing of navigating based on the navigation video may include: arranging and displaying the navigation videos matching with the navigation request information; receiving an operation for selecting one of the navigation videos from a user; playing the navigation video.

In another embodiment, the processing of navigating based on the navigation video may include: obtaining a present driving speed; determining a playing speed of the navigation video based on the present driving speed; playing the navigation video at the playing speed.

In another embodiment, when the method is applied to terminal, the method may include: synchronizing navigation data from a network, wherein the navigation data include the navigation video; storing the navigation data in a local navigation database. The processing of determining the navigation video matching with the navigation request information includes: querying for the navigation video matching with the navigation request information from the local navigation database.

The illustrations of the embodiments described herein are intended to provide a general understanding of the structure of the various embodiments. The illustrations are not intended to serve as a complete description of all of the elements and features of apparatus and systems that utilize the structures or methods described herein. Other embodiments of the disclosure will be apparent to those skilled in the art from consideration of the specification and practice of the embodiments disclosed herein. This application is intended to cover any variations, uses, or adaptations of the disclosure following the general principles thereof and including such departures from the present disclosure as come within known or customary practice in the art. It is intended that the specification and examples are considered as exemplary only, with a true scope and spirit of the invention being indicated by the following claims in addition to the disclosure.

It will be appreciated that the inventive concept is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for navigation, comprising:
obtaining navigation request information for a current navigation task;
determining at least one navigation video segment based on at least one pre-stored navigation video clip according to the navigation request information, wherein each of the at least one pre-stored navigation video clip comprises a prior recording of at least a portion of a route corresponding to the navigation request being previously driven through; and
performing the current navigation task by playing one of the at least one navigation video segment.

2. The method of claim 1, wherein the navigation request information and each pre-stored navigation video clip each comprises navigation parameters comprising at least a navigation starting point and a navigation ending point.

3. The method of claim 2, wherein determining the at least one navigation video segment comprises:
determining navigation starting point and navigation ending point of the at least one pre-stored navigation video clip; and
identifying a pre-stored navigation video clip having a navigation starting point and ending point respectively matching the navigation starting point and ending point of the current navigation task as one of the at least one navigation video segment from the at least one pre-stored navigation video clip.

4. The method of claim 2, wherein determining the at least one navigation video segment comprises:
calculating a current navigation route based on the navigation starting point and the navigation ending point of the current navigation task;
identifying a pre-stored navigation video clip from the at least one pre-stored navigation video clip having a navigation route encompassing the current navigation route; and
extracting from the identified pre-stored video clip a sub-clip as a portion of the at least one navigation video segment, wherein the extracted sub-clip corresponds to a starting and ending point matching those of the current navigation task.

5. The method of claim 2, wherein determining the at least one navigation video segment comprises:
calculating a current navigation route based on the navigation starting point and the navigation ending point of the current navigation task;
dividing the current navigation route into at least two navigation sub-routes;
identifying for each navigation sub-route a navigation video clip or sub-clip having a starting point and ending point respectively matching a starting point and ending point of each navigation sub-route; and
combining the identified navigation video clips or sub-clips for each sub-route to obtain one of the at least one navigation video segment.

6. The method of claim 2, wherein at least two navigation video segments are identified, wherein the navigation parameters further comprises at least one of a region name, a road name, a season parameter, a weather, an average driving speed, and a driving distance, the method further comprising:
obtaining at least one corresponding navigation parameter other than the starting and ending points for each of the at least two identified navigation video segments;
calculating a degree of matching of the at least one navigation parameter between the navigation request information and each of the at least two identified navigation video segments; and
determining, from the at least two identified navigation video segments, one navigation video segment having the greatest degree of matching or navigation video segments having a degree of matching higher than a preset threshold for navigating the current navigation task.

7. The method of claim 3, wherein at least two navigation video segments are identified, wherein the navigation parameters further comprises at least one of a region name, a road name, a season parameter, a weather, an average driving speed, and a driving distance, the method further comprising:
obtaining at least one corresponding navigation parameter other than the starting and ending points for each of the at least two identified navigation video segments;
calculating a degree of matching of the at least one navigation parameter between the navigation request information and each of the at least two identified navigation video segments; and
determining from, the at least two identified navigation video segments, one navigation video segment having the greatest degree of matching or navigation video segments having a degree of matching higher than a preset threshold for navigating the current navigation task.

8. The method of claim 4, wherein at least two navigation video segments are identified, wherein the navigation parameters further comprises at least one of a region name, a road name, a season parameter, a weather, an average driving speed, and a driving distance, the method further comprising:
obtaining at least one corresponding navigation parameter other than the starting and ending points for each of the at least two identified navigation video segments;
calculating a degree of matching of the at least one navigation parameter between the navigation request information and each of the at least two identified navigation video segments; and
determining from, the at least two identified navigation video segments, one navigation video segment having the greatest degree of matching or navigation video segments having a degree of matching higher than a preset threshold for navigating the current navigation task.

9. The method of claim 6, further comprising:
presenting at least one navigation parameter associated with the at least two navigation video segments to a user; and
receiving a selection from the user for one of the at least two navigation video segments based on the presented at least one navigation parameter for navigating the current navigation task.

10. The method of claim 1, further comprising obtaining a present driving speed, wherein navigating the current navigation task by playing one of the at least one navigation video segment comprising playing one of the at least one navigation video at a playing speed determined based on the present driving speed.

11. A method for generating a navigation video clip, comprising:
obtaining navigation parameters entered by a user, wherein the navigation parameters comprise at least a navigation starting point and a navigation ending point;
recording a video of roads while driving from the navigation starting point to the navigation ending point;
associating the navigation parameters with the recorded video to obtain the navigation video clip; and
uploading the navigation video clip to a database.

12. The method of claim 11, further comprising:
recording a driving speed continuously or periodically while recording the video;
calculating an average driving speed based on the recorded driving speed; and
associating the average driving speed with the recorded video when obtaining the navigation video clip.

13. The method of claim 11, further comprising:
obtaining route markers while recording the video; and
associating the route markers with the recorded video when obtaining the navigation video clip.

14. A device for navigation, comprising:
a processor;
a memory for storing instructions executable by the processor;
wherein the processor is configured to:
obtain navigation request information for a current navigation task;
determine at least one navigation video segment based on at least one pre-stored navigation video clips according to the navigation request information, wherein each of the at least one pre-stored navigation video clip comprises a prior recording of at least a portion of a route corresponding to the navigation request being previously driven through; and
perform the current navigation task by playing one of the at least one navigation video segment.

15. The device of claim 14, wherein the navigation request information and each pre-stored navigation video clip each comprises navigation parameters comprising at least a navigation starting point and a navigation ending point, and wherein, to determine the at least one navigation video segment, the processor is configured to:
determine navigation starting point and navigation ending point of the at least one pre-stored navigation video clip; and
identify a pre-stored navigation video clip having a navigation starting point and ending point respectively matching the navigation starting point and ending point of the current navigation task as one of the at least one navigation video segment from the at least one pre-stored navigation video clip.

16. The device of claim 14, wherein the navigation request information and each pre-stored navigation video clip each comprises navigation parameters comprising at least a navigation starting point and a navigation ending point, and wherein to determine the at least one navigation video segment, the processor is further configured to:
calculate a current navigation route based on the navigation starting point and the navigation ending point of the current navigation task;
identify a pre-stored navigation video clip from the at least one pre-stored navigation video clip having a navigation route encompassing the current navigation route; and
extract from the identified pre-stored video clip a sub-clip as a portion of the at least one navigation video segment, wherein the extracted sub-clip corresponds to a starting and ending point matching those of the current navigation task.

17. The device of claim 14, wherein the navigation request information and each pre-stored navigation video clip each comprises navigation parameters comprising at least a navigation starting point and a navigation ending point, and wherein to determine the at least one navigation video segment, the processor is further configured to:
calculate a current navigation route based on the navigation starting point and the navigation ending point of the current navigation task;
divide the current navigation route into at least two navigation sub-routes;
identify for each navigation sub-route a navigation video clip or sub-clip having a starting point and ending point respectively matching a starting point and ending point of each navigation sub-route; and
combine the identified navigation video clips or sub-clips for each sub-route to obtain one of the at least one navigation video segment.

18. The device of claim 14, wherein the navigation request information and each pre-stored navigation video clip each comprises navigation parameters comprising at least a navigation starting point and a navigation ending point, wherein at least two navigation video segments are identified by the processor, wherein the navigation parameters further comprises at least one of a region name, a road name, a season parameter, weather parameter, an average driving speed, and a driving distance, and wherein the processor is further configured to:
obtain at least one corresponding navigation parameter other than the starting and ending points for each of the at least two identified navigation video segments;
calculate a degree of matching of the at least one navigation parameter between the navigation request information and each of the at least two identified navigation video segments; and
determine, from the at least two identified navigation video segments, one navigation video segment having the greatest degree of matching or navigation video segments having a degree of matching higher than a preset threshold for navigating the current navigation task.

19. The device of claim 18, wherein the processor is further configured to:
present at least one navigation parameter associated with the at least two navigation video segments to a user; and
receive a selection from the user for one of the at least two navigation video segments based on the presented at least one navigation parameter for navigating the current navigation task.

20. The device of claim 14, wherein the processor is further configured to obtain a present driving speed, and wherein, when to navigate the current navigation task by playing one of the at least one navigation video segment, the processor is configured to play one of the at least one navigation video at a playing speed determined based on the present driving speed.
